(19) United States
(12) Patent Application Publication
(10) Pub. No.: US 2019/0313513 A1
(43) Pub. Date: Oct. 10, 2019

(54) Modular LED Driving System for Architectural and Entertainment Lighting Systems

(71) Applicant: Tom Somodi, Pardeeville, WI (US)

(72) Inventor: Tom Somodi, Pardeeville, WI (US)

(21) Appl. No.: 16/374,853

(22) Filed: Apr. 4, 2019

Related U.S. Application Data
(60) Provisional application No. 62/652,414, filed on Apr. 4, 2018.

(51) Int. Cl. H05B 37/02; H05B 33/08

(52) U.S. Cl. CPC H05B 37/0254; H05B 33/0845

(57) ABSTRACT

A modular power supply system for LED light fixtures provides a master circuit card interpreting digital lighting control signals received over a first communication channel and providing power control signals to servant circuit cards receiving the power control signals to control voltage converters to provide independent power outputs to LED lamps according to the power control signals.

### CROSS REFERENCE TO RELATED APPLICATION

This application claims the benefit of U.S. provisional application 62/652,414 filed Apr. 4, 2018 and hereby incorporated by reference in its entirety.

### BACKGROUND OF THE INVENTION

The present invention relates generally to LED driving systems useful for lighting and in particular to a modular system that can be quickly tailored to a variety of different lighting applications.

Early lighting control systems for theater and architectural applications employed a central dimmer panel with high-powered conductors leading to each lighting unit, typically incandescent lights, the conductors distributing the necessary power as preprocessed by the dimmer panel to produce the desired light level. With the advent of LED lighting and low-cost microprocessor systems, it is currently typical for each lighting unit to be closely associated with an individual dimmable power supply and the central dimmer panel, if used, to distribute digital signals controlling the dimmable power supplies to generate the desired lighting level. In this way the need to provide high-powered conductors from a central source to each lighting unit is eliminated.

The digital signals used for such distributed control, for example, may be according to the known DMX 512 or RS-485 standards which provide some compatibility across lighting suppliers.

Manufacturers of lighting units or lighting assemblies will normally design custom circuitry to provide the necessary power to the LED lighting units. In the simplest case, this custom circuitry receives electrical power at a nominal voltage and provides a regulated current to the LED lamps as required by LED devices. The circuitry may employ a so-called “buck” or “boost” type circuitry operating with feedback to regulate current to the desired levels and voltages which may be defined by component values of the circuitry or programmable switches or the like. If remote control of the lighting units is desired, the circuitry may incorporate circuitry (typically a microprocessor) to decode the digital control signals and to implement simple control routines controlling the output current according to these control signals. Depending on the power required by the lighting unit, different circuit designs are required using different components and coupling the circuitry with different power supplies and cooling systems.

The wide variety of lighting systems and applications used in entertainment and architectural situations normally require a custom circuit, power supply, and enclosure to be prepared for each such application greatly increasing the costs of such systems.

### SUMMARY OF THE INVENTION

The present invention provides a modular LED driver system using preprepared circuit cards that may be assembled in modular fashion to address a wide variety of power output requirements. In addition, the housing accommodating the circuit cards may be modular largely eliminating the need for custom circuit design and housing construction. By providing master and servant modules, power output can be readily scaled without the need for unnecessary duplicated components to decode digital control signals and implement control routines. This arrangement also allows extremely simple configurations requiring servant modules only.

These particular objects and advantages may apply to only some embodiments falling within the claims and thus do not define the scope of the invention.

### BRIEF DESCRIPTION OF THE DRAWINGS

FIG. 1 is an exploded diagram of one embodiment of the modular system showing a standard housing that can receive a different number of modular circuit cards to implement a particular lighting power supply system;

FIG. 2 is a block diagram of a master circuit card communicating with one servant circuit card providing scalability of the solution; and

FIGS. 3a-3c are different embodiments of the housing system that can scale with the number of required circuit cards.

### DETAILED DESCRIPTION OF THE PREFERRED EMBODIMENT

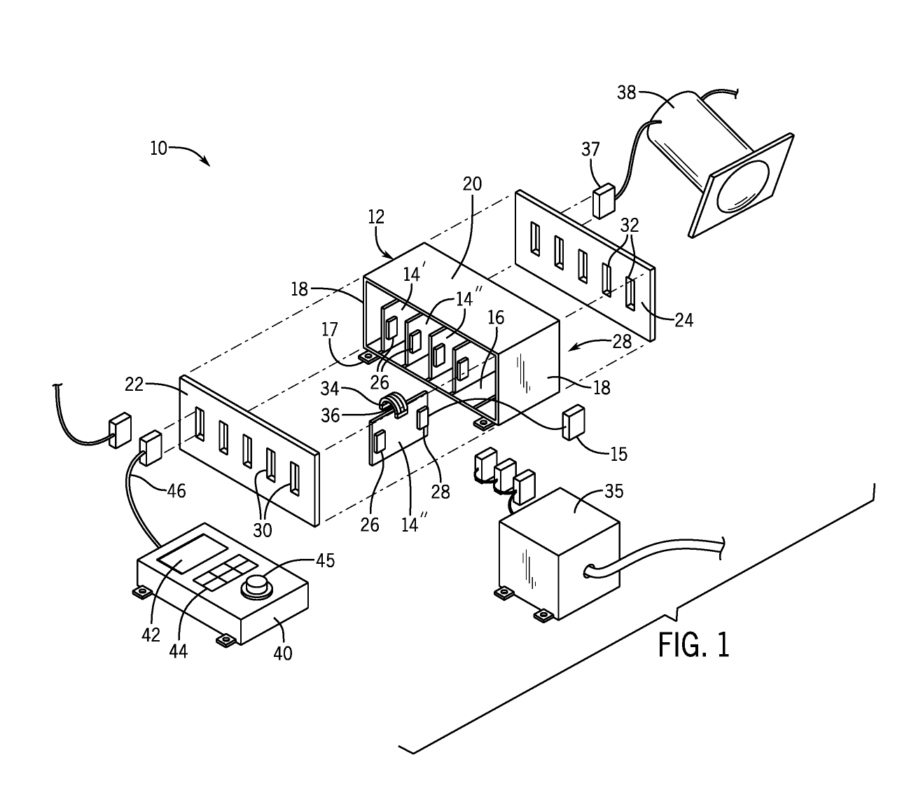

Referring now to FIG. 1, a modular LED lighting power system 10 of the present invention may provide for a housing 12 that may accept a set of printed circuit cards 14 arrayed to extend in parallel vertical planes in separated slots within the volume of the housing 12. The circuit cards 14 may include a master circuit card 14′ and one or more servant circuit cards 14″ as will be discussed below.

The housing 12 may generally provide for a planar baseplate 16 having opposed upstanding sidewalls 18 joined with respective top edges by a spanning top plate 20. Each of the baseplate 16, sidewalls 18, and top plate 20 may be an electrically and thermally conductive material such as aluminum and may thermally and electrically intercommunicate to provide electrical shielding and a common heat sink. A second baseplate 17 may optionally attach under the first baseplate 16 and have tabs to allow the housing 12 to be mounted to a surface.

An optional metal front panel 22 may attach over a front opening of the housing 12 on one side, for example, by machine screws or the like, and similarly an optional metal rear panel 24 may attach over and opposed rear opening of the housing by similar machine screws or the like to complete a Faraday shield provided by the housing 12.

Each of the circuit cards 14, for example, may provide for an aluminum core circuit card capable of communicating heat from components on the circuit card to the walls of the housing 12 by direct mechanical contact, for example, through mounting brackets or the like. Opposed vertical edges of the circuit cards 14 at the front and rear of the housing 12 support releasable electrical connectors 26 and 28 that may be exposed through apertures 30 and 32 cut in the front panel 22 and rear panel 24 respectively so that these connectors 26 and 28 may attach to external circuits and devices as will be described. Generally, the connectors 26 may each receive electrical power provided by a power supply 35 which may be shared or centralized among many servant modules. One connector 26 (associated with master circuit cards 14′) may receive control signals such as DMX/RDM using for example RS 482 transport.

The output connectors 28 may provide connections to connectors 37 providing electrical current to lighting units 38 or a fan 15 that may be used to provide supplemental forced convection cooling if required when the housing 12 is incorporated into a larger assembly such as a light fixture. Generally, the output connectors 28 associated with each circuit card 14 may drive different light fixtures 38 or may be connected in parallel to drive a light fixture 38.

The circuit cards 14 also include connectors 34 which may attach to ribbon cables 36 providing a daisy chained communication between each of the circuit cards 14. This communication allows coordination of master and servant cards and may, for example, employ a number of communication protocols including but not limited to SPI, UART, and I2C protocols known in the art.

The modular LED lighting power system 10 may include a local control module 40, for example, allowing adjustment of parameters such as units DMX address. Optionally this local control module 40 may provide a simplified user interface including an LCD display 42, a membrane switch 44, and optionally a control knob 45 that may be used to provide control signals through a cable 46 connecting the connector 26 to the master circuit card 14′. This local control module 40 may be functionally equivalent to a standard dimmer panel but of lower cost and may allow for local (proximate to the lighting units 38) lighting level control including the execution of simple lighting sequences. Alternatively, the connector 26 of circuit card 14′ may connect to a standard remote lighting panel or the like.

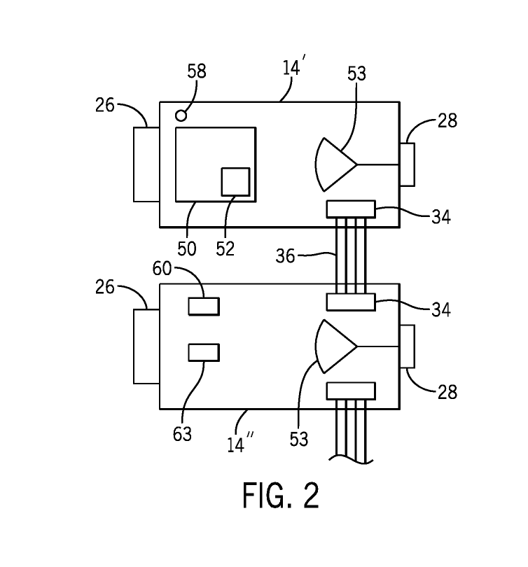

Referring now to FIG. 2, the master circuit card 14′ may include a microprocessor 50 executing a stored firmware program 52 to interpret digital control signals received over connector 26 relating to control of the output of the circuit cards 14 such as may be used to invoke dimming of the LED lighting units 38 or the execution of prestored lighting routines. The microprocessor 50 controls a current-controlled current source 53 receiving power through connector 26 to produce a given current level communicated through connector 28. The circuitry of current source 53 may implement a buck or boost converter of a type well known in the art, for example, providing an analog output voltage or pulse width modulated DC voltage having a desired average analog current value. Signals from the microprocessor 50 to the current source 53 are also relayed by means of connectors 34 and ribbon cable 36, optionally, to one or more servant circuit boards 14″ allowing the maximum amount of power handled by the modular LED lighting power system 10 to be easily adjusted simply by adding additional servant circuit cards 14″. The master circuit card 14′ may also include a temperature sensor 58 communicating with the microprocessor 50 and used to control activation of a fan (not shown), for example, associated with the ventilation opening 15 of the housing 12.

The servant circuit cards 14″ may include a simpler microprocessor 60 than the one provided on the master circuit card 14′ and need not interpret digital control signals from a remote device. The servant circuit cards 14′ may also provide onboard programming by means of switches 63 or replaceable resistors or the like to be used without a master circuit card 14′ if desired to produce a steady programmed output power with the controlled current.

Generally, the output voltage of each circuit card 14 may vary from 56 to 36 volts and may provide a power output of approximately 100 Watts so that a total of 500 Watts of output power may be created with a master control circuit card 14′ and four servant control boards 14″, for example. Preferably the output is current-controlled to a predetermined current value independent of the load.

The signals received by the master circuit card 14′ may be high-level signals that describe, for example, a sequence of lighting effects such as a gradual fade-in over a predetermined time period or fade-out, or other sequence. The outputs provided by the master circuit card 14′ to the servant circuit cards 14″ are generally primitive commands indicating a particular voltage and current value. Accordingly, the servant circuit cards 14″ may have reduced computational requirements. The ability to divorce the master circuit card circuitry 14′ from this circuitry of the servant circuit cards 14″ allows greater flexibility in accommodating the power requirements of various LED fixtures and allows the production of a lower cost system when multiple independent control signals are required by eliminating the need for multiple master control circuit cards 14′. This approach also allows the sharing of a power supply among the servant circuit cards 14″ and placement of that power supply closer to the proximity of the LED lamps.

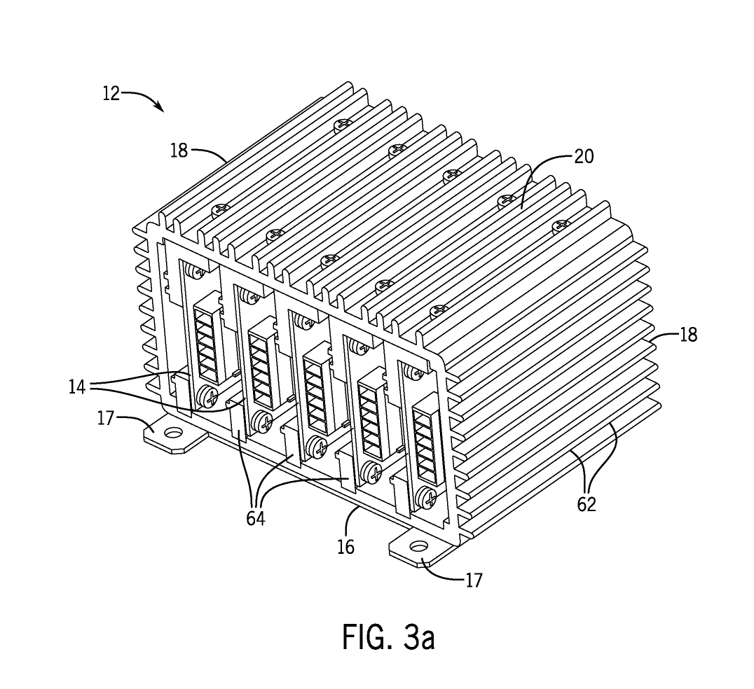

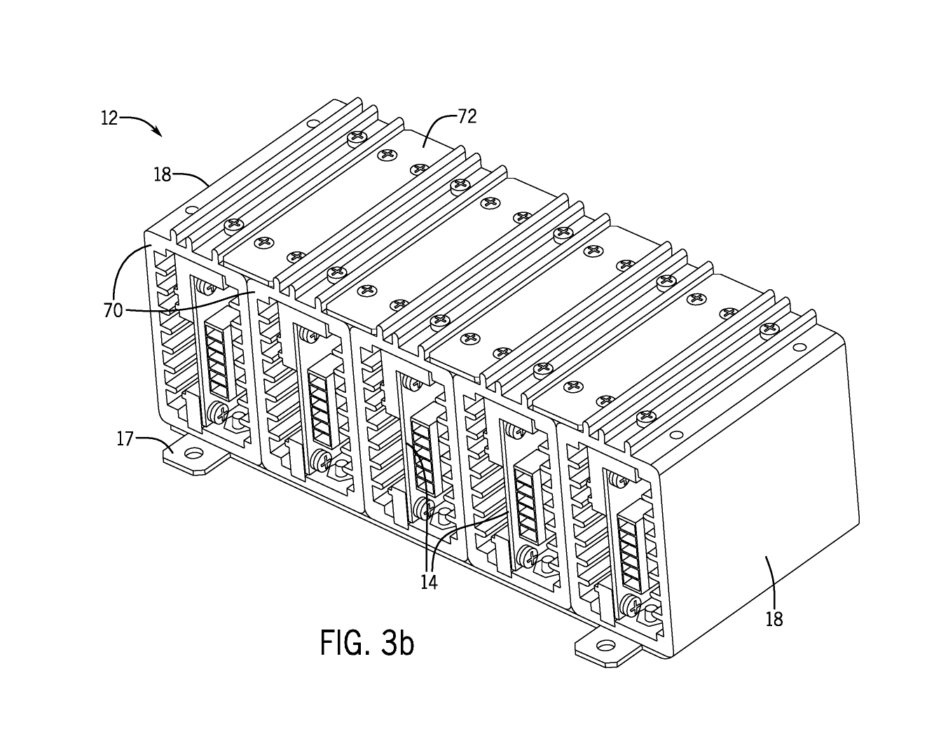

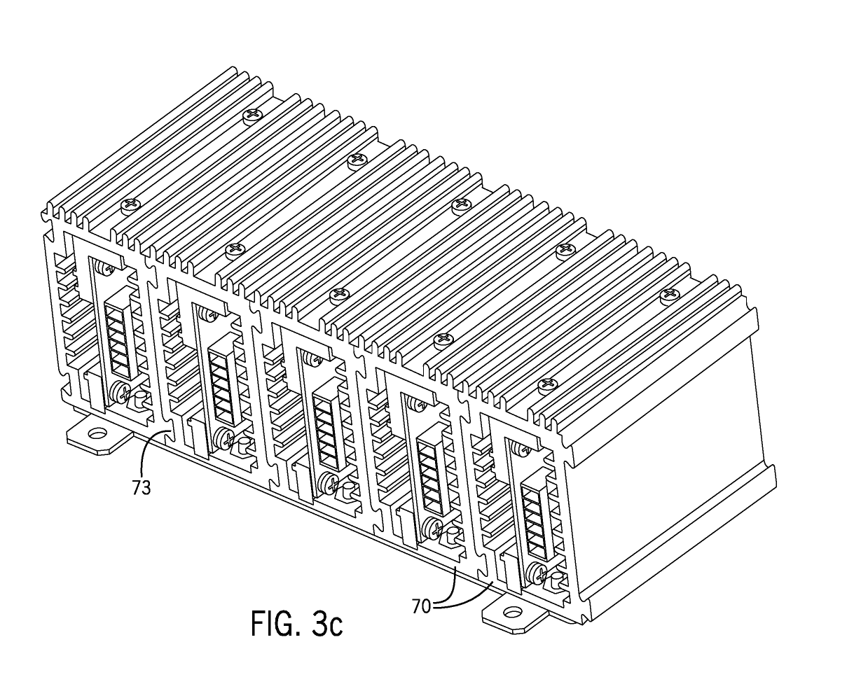

Referring now to FIG. 3a, the housing 12 may be constructed, for example, by an extruded aluminum shape forming the top plate 20, baseplate 16, and the sidewalls 18, as an integrated unit. The extrusion may have outward fins 62 to improve heat sinking capability and heat transfer to the air so that the modular LED lighting power system 10 may operate without a fan at ambient air temperatures. Each of the circuit cards 14 may attach to metallic brackets 64 providing a low thermal resistance connection to the housing 12 for heat escape.

Referring now to FIG. 3b, in an alternate design, the housing 12 may be formed from a set of different extrusions 70 that are attached side-by-side by connector plates 72 (joining the extrusion 70 by machine screws). The vertical walls of the outermost extrusions 70 form the vertical walls 18 of the housing 12, and the remaining walls vertical walls abut each other for exchange of heat therebetween. In this design, the number of extrusions 70 may be varied according to the number of servant or master cards 14 allowing improve modularity in the housing 12.

Referring to FIG. 3c, in yet another alternative embodiment the connector plate 72 may be eliminated in favor of an extruded dovetail connection 73 connecting the extrusions 70 to each other eliminating the need for the connector plates 72.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A modular power supply system for LED light fixtures comprising:
a master circuit card including a processor executing a stored program to interpret digital lighting control signals received over a first communication channel and providing power control signals; and
at least two servant circuit cards receiving the power control signals to control voltage converters to provide independent power outputs to LED lamps according to the power control signals.
